(19) United States
(12) Patent Application Publication
(10) Pub. No.: US 2015/0064369 A1
(43) Pub. Date: Mar. 5, 2015

(54) PAPERCLIP COLLECTOR

(71) Applicant: Kuo-Ching CHIANG, New Taipei City (TW)

(72) Inventor: Kuo-Ching CHIANG, New Taipei City (TW)

(21) Appl. No.: 14/010,569

(22) Filed: Aug. 27, 2013

(51) Int. Cl. B43M 99/00

(52) U.S. Cl. CPC B43M 99/009
USPC 428/16

(57) ABSTRACT

The paperclip collector includes a people head part having a shape of the people head; at least a magnet is formed in inner side of a head top of the people head part, wherein an outer surface outside the head top acts as a paperclip collecting area; wherein a plurality of paperclips is located on the paperclip collecting area to allow the paperclips looks like a hair of the people head.

### TECHNICAL BACKGROUND

1. Technical Field

The invention relates generally to the field of paperclip collector and more particularly, to dolls and puppets with paperclip collecting features.

2. Description of Related Arts

Paperclips are very help for the daily office document works. However, it is very hard to collect them. Typically, they are sealed in a box, otherwise they will be disorderly located over the desk.

### SUMMARY

The paperclip collector includes a people head figure part having a shape of the people head; at least a magnet is formed in inner side of the head top of the people head figure part.

The outer surface outside the head top acts as a paperclip collecting area; wherein a plurality of paperclips is located on the paperclip collecting area, and the gathered paperclips looks like a hair of the people head.

A surface of the paperclip collecting area is uneven. The people head part includes a face part onto which individual features including eyes, nose, eye brush and ears are established. The material for the people head part includes plastic, rubber, wood, ceramic, glass, crystal or polymer. Other aspects, features, and advantages will be set forth in the description that follows.

### BRIEF DESCRIPTION OF THE DRAWINGS

FIG. 1 is a view of an embodiment of the invention with shape of people.

FIG. 2 is cross-sectional views illustrating the shape of people of FIG. 1.

FIG. 3 a view of an embodiment of the invention illustrates the status of collecting the paperclips.

### DETAILED DESCRIPTION

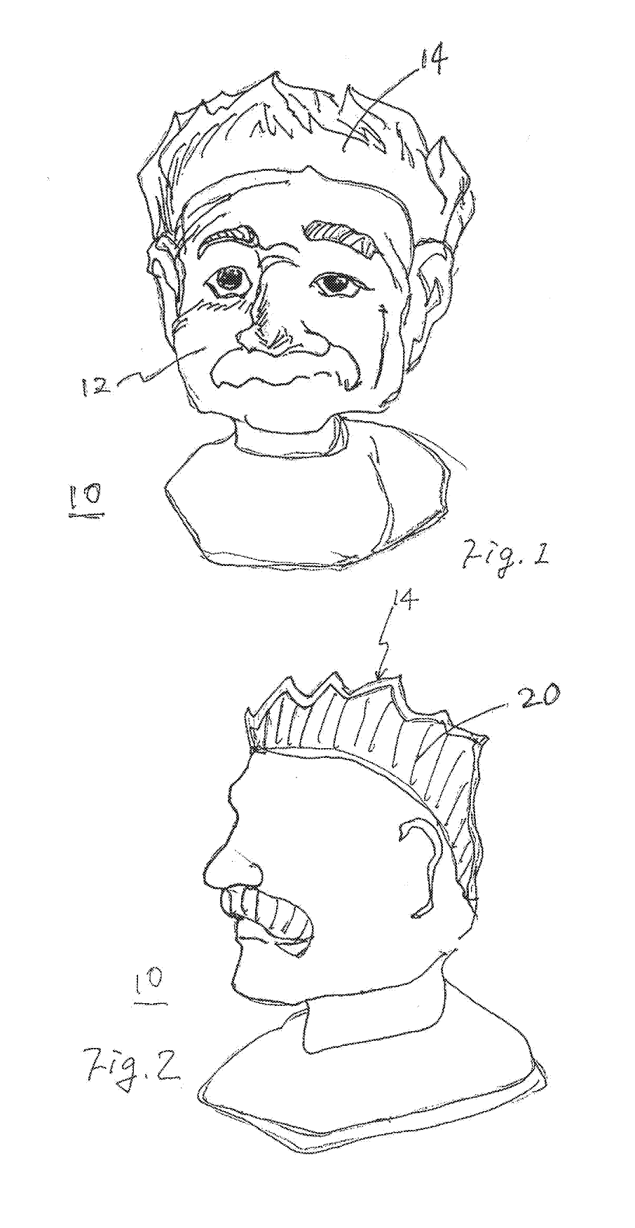

FIG. 1 shows the embodiment of the present invention, the paperclip collector includes a people head figure part 10. The people head figure part 10 has a shape of the people head onto which a plurality of individual features, for instant, eyes, nose, eye brush and ears have been established on a face part 12. The material for the people head part 10 may be, for example, plastic, rubber, wood, ceramic, glass, crystal or polymer.

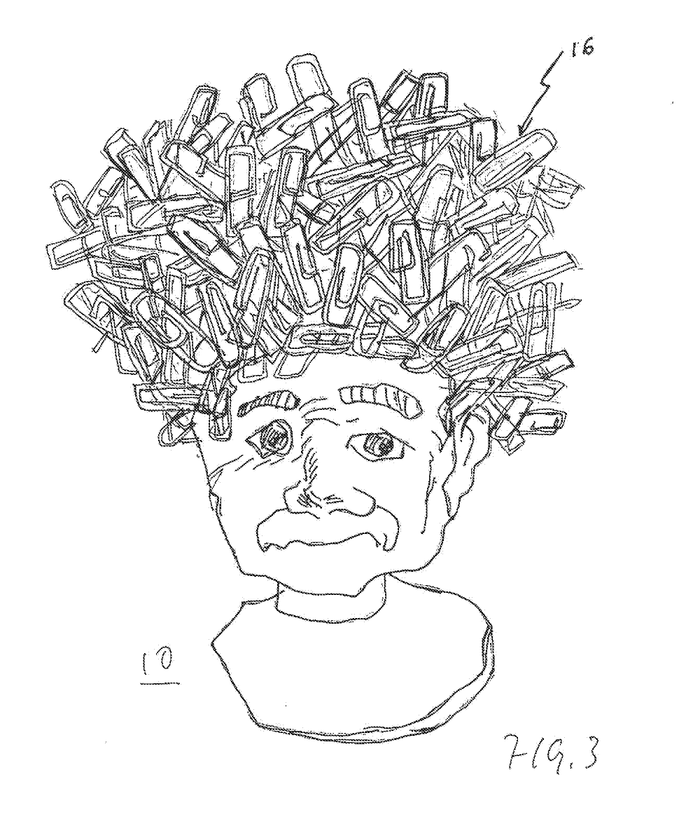

FIG. 2 shows the embodiment of the present invention, the present invention includes at least a magnet 20 formed with the inner side of the head of the people head figure part 10. The outer surface outside the head top and/or back acts as the paperclip collecting area 14. The people head figure part 10 may have any people shape. In other embodiments, portions of the people head part may be stuffed and closed.

FIG. 3 is a view of the paperclip collector after the paperclips are located on the paperclip collecting area 14. The paperclips 16 will be attacked by the magnet 20 and stay on the paperclip collecting area 14. The collected paperclips over the head top and back will be look like the hair of the people head. In order to construct the visual effect, the surface of the paperclip collecting area 14 is uneven.

While the invention has been described with respect to certain embodiments, the description is intended to be exemplary, rather than limiting. Modifications and changes may be made within the scope of the invention, which is defined by the appended claims.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure. While the preferred embodiment of the invention has been illustrated and described, it will be appreciated that various changes can be made therein without departing from the spirit and scope of the invention.

I claim:

1. A paperclip collector, comprising:
a people head part having a shape of the people head; and
at least a magnet formed in an inner side of a head top of the people head part, wherein an outer surface outside the head top acts as a paperclip collecting area;
wherein a plurality of paperclips is located on the paperclip collecting area, to allow the plurality of paperclips looks like a hair of the people head.

2. The paperclip collector of claim 1, wherein a surface of the paperclip collecting area is uneven.

3. The paperclip collector of claim 1, wherein the people head part includes a face part onto which a plurality of individual features include eyes, nose, eye brush and ears.

4. The paperclip collector of claim 1, wherein a material for the people head part includes plastic, rubber, wood, ceramic, glass, crystal or polymer.
